(19) United States
(12) Patent Application Publication
(10) Pub. No.: US 2006/0106772 A1
(43) Pub. Date: May 18, 2006

(54) Optimization of communication of data structures using program analysis

(75) Inventors: Alan A. Donovan, New York, NY (US); Stephen J. Fink, Yorktown Heights, NY (US); Darrell Reimer, Tarrytown, NY (US)

Correspondence Address: MICHAEL J. BUCHENHORNER, ESQ;HOLLAND & KNIGHT, 701 BRICKELL AVENUE, MIAMI, FL, 33131, US

(73) Assignee: International Business Machines Corporation

(21) Appl. No.: 10/989,143

(22) Filed: Nov. 15, 2004

(51) Int. Cl. G06F 17/30

(52) U.S. Cl. 707/3

(57) ABSTRACT

A method for regulating communication of information in a data structure between components of a computer program is disclosed. The method includes reading a computer program and automatically identifying fields of a data structure that must be transmitted from a first component of the computer program to a second component of the computer program. The method further includes generating a routine that indicates the fields of the data structure that were identified. The method further includes requiring the first component to execute the routine when sending the data structure to the second component, such that the first component only marshals the fields of the data structure that are indicated by the routine.

### CROSS-REFERENCE TO RELATED APPLICATIONS

Not Applicable.

### STATEMENT REGARDING FEDERALLY SPONSORED-RESEARCH OR DEVELOPMENT

Not Applicable. INCORPORATION BY REFERENCE OF MATERIAL SUBMITTED ON A COMPACT DISC

Not Applicable.

### FIELD OF THE INVENTION

The invention disclosed broadly relates to the field of communications and more particularly relates to the field of communication of data structures between computer nodes.

### BACKGROUND OF THE INVENTION

Communicating processes in software systems require sharing of data and often communicate by exchanging messages containing the necessary data. Historically, message-passing processes spend a significant computational effort marshalling the data: gathering the relevant parts of the data from the memory of the sending program, and assembling them into a canonical serial format (or wire protocol). This serialized data is then transmitted to the receiver process—for example, by writing it to a file or by streaming it over a network—which then unmarshals the message into the desired format.

Some programming languages provide facilities to automate this process, which is often referred to as serialization. Typically, a serialization library uses class meta-data, which is provided by the programming language's runtime-system. This meta-data describes the structure of the types and data structures in the system, and enables the serialization support to automatically marshal and unmarshal program data structures. The whole process may be completely transparent to the user, encapsulated by a single procedure call—for example, send(x) in the sender, y:=recv( ) in the receiver. Although this automatic facility reduces programmer effort, it may introduce significant computational work if the serialized data structure is large.

As an optimization, some object-oriented programming languages allow the user to specify that object-graph edges originating at certain object fields are not to be traversed during marshalling. In object oriented programming languages, a data structure will often be represented as a graph of objects, wherein each object in the data structure contains fields that hold pointers or references to other objects in the data structure. For some data structures, this annotation can significantly reduce the size of the serialized format. Reachable fields so marked are not considered part of the persistent state of the object, but may be used to hold derived or cached values, for example.

For example, the Java standard library contains a serialization mechanism in the classes java.util.ObjectOutputStream and java.util.ObjectInputStream. The programmer may label fields of Java classes transient to prevent them from being serialized. One major limitation of this approach is that Java only allows a pointer to be declared transient of not depending on the declared field. The contents of a particular field will either always be transient and thus not communicated, or will always be considered persistent and communicated. However, there are situations where better performance could be obtained if one could defer the decision of what data to communicate until run-time, when more information is available.

Therefore, there is a need to overcome problems with the prior art as discussed above, and more particularly a need to make the process of communicating data structures more efficient.

### SUMMARY OF THE INVENTION

Briefly, according to an embodiment of the invention, a method for regulating communication of information in a data structure between components of a computer program is disclosed. The method includes reading a computer program and automatically identifying fields of a data structure that must be transmitted from a first component of the computer program to a second component of the computer program. The method further includes generating a routine that indicates the fields of the data structure that were identified. The method further includes requiring the first component to execute the routine when sending the data structure to the second component, such that the first component only marshals the fields of the data structure that are indicated by the routine.

In another embodiment of the present invention, an information processing system for regulating communication of information in a data structure between components of a computer program is disclosed. The information processing system includes a reader for reading a computer program. The information processing system further includes a processor configured for automatically identifying fields of a data structure that must be transmitted from a first component of the computer program to a second component of the computer program, generating a routine that indicates the fields of the data structure that were identified, and requiring the first component to execute the routine when sending the data structure to the second component, such that the first component only marshals the fields of the data structure that are indicated by the routine.

In yet another embodiment of the present invention, a computer readable medium including computer instructions for regulating communication of information in a data structure between components of a computer program is disclosed. The computer instructions include instructions for reading a computer program and automatically identifying fields of a data structure that must be transmitted from a first component of the computer program to a second component of the computer program. The computer instructions further include instructions for generating a routine that indicates the fields of the data structure that were identified and requiring the first component to execute the routine when sending the data structure to the second component, such that the first component only marshals the fields of the data structure that are indicated by the routine.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is block diagram showing a high-level network architecture of one embodiment of the present invention.

FIG. 2 is a flow chart depicting the control flow of the marshalling process, in one embodiment of the present invention.

FIG. 3 is a flow chart depicting the control flow of the unmarshalling process, in one embodiment of the present invention.

FIG. 4 is a block diagram depicting the marshalling process, in one embodiment of the present invention.

FIG. 5 is a block diagram depicting the unmarshalling process, in one embodiment of the present invention.

FIG. 6 is a flow chart depicting the control flow of the process of identifying portions of a data structure, in one embodiment of the present invention.

FIG. 7 is a high level block diagram showing an information processing system useful for implementing one embodiment of the present invention.

### DETAILED DESCRIPTION

The present invention provides a method, computer readable medium and information processing system for regulating communication of information in a data structure, such as an object, between applications or among components of a computer program. The present invention automatically analyzes a set of communicating applications, computer programs or components thereof and identifies portions of data structures that can be omitted from individual messages, without impacting computer program semantics. The present invention can be used either to provide recommendations via a tool on how to specify data structure annotations, or to automatically set annotations without computer programmer intervention.

In one embodiment of the present invention, the method of the present invention results in a decision procedure embodied in a function, method or computer program routine that is consulted when a send action is initiated. When a first application, computer program or components thereof requests to send information in an object to a second application, the decision procedure is executed. The decision procedure identifies those portions of the object that must be transmitted. Subsequently, the portions of the object that were identified are marshalled and transmitted to the second application.

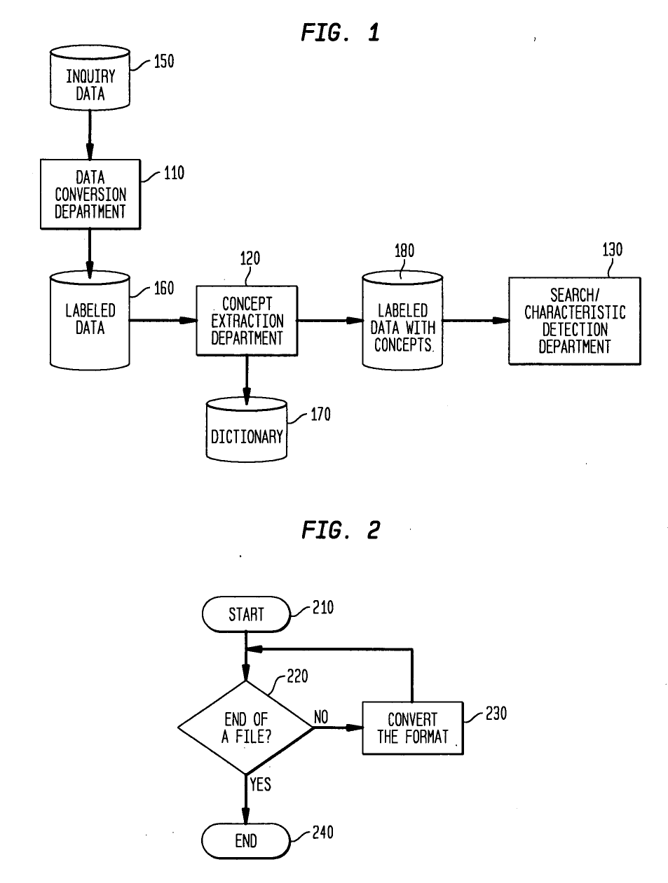

FIG. 1 is block diagram showing a high-level network architecture of one embodiment of the present invention. FIG. 1 shows a first node 102 and a second node 104 connected to a network 106. Nodes 102 and 104 can be computer programs, components of computer programs, applications, components of a larger application, computers running applications or any other information processing systems capable of executing applications. In an embodiment of the present invention, nodes 102 and 104 can comprise any commercially available computing system that can be programmed to offer the functions of the present invention. In another embodiment of the present invention, node 104 can comprise a client computer running a client application that interacts with a node 102 as a server computer in a client-server relationship.

In an embodiment where nodes 102 and 104 are applications or components of applications, the nodes can be implemented as hardware, software or any combination of the two. The applications or components of applications can be located in a distributed fashion in both nodes 102 and 104, as well as other nodes. In this embodiment, the applications or components of applications of nodes 102 and 104 operate in a distributed computing paradigm.

FIG. 1 further shows a data structure 108, such as an object, including information, such as variables, constants, fields, pointers, other objects and the like. In an embodiment of the present invention, the data structure 108 can be any data structure of an object-oriented programming language. The process of the present invention, allows for certain portions of the information in data structure 108 to be marshalled by node 102, transmitted through the network 106 and received by node 104, where the information is unmarshalled. This process is described in greater detail with reference to the figures below.

In an embodiment of the present invention, the computer systems of the nodes 102 and 104 are one or more Personal Computers (PCs) (e.g., IBM or compatible PC workstations running the Microsoft Windows operating system, Macintosh computers running the Mac OS operating system, or equivalent), Personal Digital Assistants (PDAs), hand held computers, palm top computers, smart phones, game consoles or any other information processing devices. In another embodiment, the computer systems of the nodes 102 and 104 are a server system (e.g., SUN Ultra workstations running the SunOS operating system or IBM RS/6000 workstations and servers running the AIX operating system). The computer systems of the nodes 102 and 104 are described in greater detail below with reference to FIG. 5.

In an embodiment of the present invention, the network 106 is a circuit switched network, such as the Public Service Telephone Network (PSTN). In another embodiment, the network 106 is a packet switched network. The packet switched network is a wide area network (WAN), such as the global Internet, a private WAN, a local area network (LAN), a telecommunications network or any combination of the above-mentioned networks. In yet another embodiment, the network 106 is a wired network, a wireless network, a broadcast network or a point-to-point network.

It should be noted that although nodes 102 and 104 are shown as separate entities in FIG. 1, the functions of both entities may be integrated into one entity. It should also be noted that although FIG. 1 shows only two nodes, the present invention supports any number of nodes.

FIG. 2 is a flow chart depicting the control flow of the marshalling process, in one embodiment of the present invention. FIG. 2 shows the sequence of events that occur when an application or component of an application, such as node 102, marshals data for transmission to a second node 104. The control flow of FIG. 2 begins with step 202 and flows directly to step 204. In step 204, the serialization process at node 102 is initiated, for example, by node 102 in an attempt to send required data, from a data structure 108, to node 104. This action spawns the initiation of the decision procedure of the present invention.

In step 206, the decision procedure executes. In step 208, the decision procedure identifies portions of the data structure 108 for marshalling. In step 210, based on the portions of the data structure 108 that were identified in step 208 above, the serialization process marshals the portions of the data structure 108 that were identified. In step 212, the marshaled data is transmitted to the second node 104. In step 214, the control flow of FIG. 2 ceases.

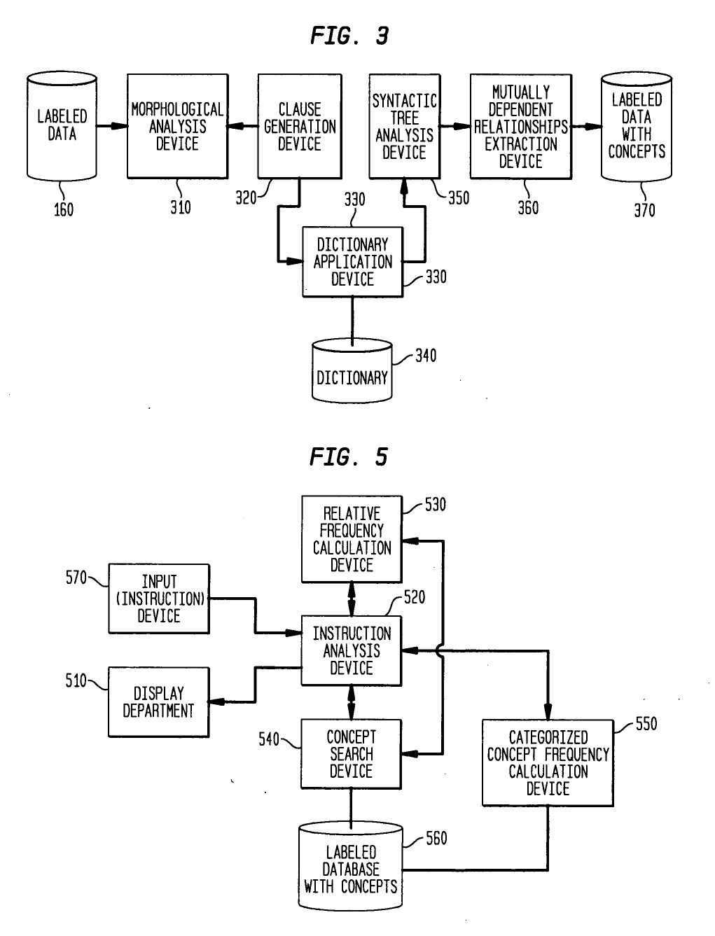

FIG. 3 is a flow chart depicting the control flow of the unmarshalling process, in one embodiment of the present invention. FIG. 3 shows the sequence of events that occur when an application or component of an application, such as node 104, unmarshals data received from node 102. The control flow of FIG. 3 begins with step 302 and flows directly to step 304. In step 304, the de-serialization process at node 104 is initiated, for example, by node 104 in an attempt to receive and unmarshal required data, from a data structure 108, sent by node 102. This action spawns the initiation of the decision procedure of the present invention.

In step 306, the marshaled data is received by the second node 104. In step 308, the decision procedure executes. In step 310, the decision procedure identifies portions of the data structure 108 for unmarshalling. In step 312, based on the portions of the data structure 108 that were identified in step 310 above, the de-serialization process unmarshals the portions of the data structure 108 that were identified. In step 314, the control flow of FIG. 3 ceases.

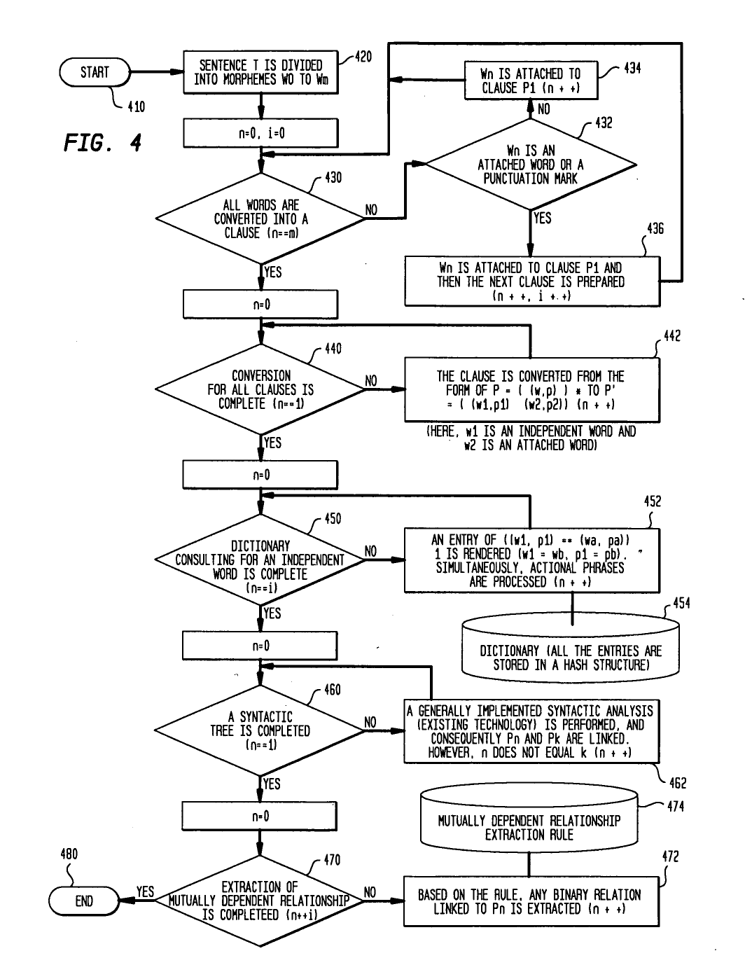

FIG. 4 is a block diagram depicting the marshalling process, in one embodiment of the present invention. FIG. 4 shows a data structure, such as object 402, including information such as variables, constants, fields, pointers, other objects and the like. Object 402 includes four data fields, filed 404, field 406, field 408 and field 410. The node 102 receives a request to transmit data from the object 402 to the node 104. The serializer 412, representing the serialization process of the node 102, consults the decision procedure 416 of the present invention, wherein certain portions of the object 402 are identified for marshalling and transmission. The decision procedure decides that fields 406 and 410 shall be marshalled for transmission to node 104. Fields 404 and 408 shall not be marshalled for transmission to node 104.

Subsequently, the serializer 412 marshals the fields 406 and 410 and produces the serialized data 414, which is then transmitted to the node 104 via the network 106.

FIG. 5 is a block diagram depicting the unmarshalling process, in one embodiment of the present invention. FIG. 5 shows that the serialized data 414 is received by the node 104 from node 102 via the network 106.

FIG. 5 shows a data structure, such as object 502, including information such as that described for object 402 in FIG. 4 above. Object 502 includes four data fields, filed 504, field 506, field 508 and field 510. The node 104 receives a request to receive data for the object 502. The de-serializer 512, representing the de-serialization process of the node 104, consults the decision procedure 516 of the present invention, wherein certain portions of the serialized data 414 are identified for unmarshalling into object 502. The decision procedure decides that fields 506 and 510 shall be unmarshalled from the serialized data 414. Information for fields 504 and 508 shall not be unmarshalled from the serialized data 414. Subsequently, the de-serializer 512 unmarshals data from the serialized data 414 into fields 506 and 510.

The present invention is directed towards a method for identifying portions of a data structure, such as an object, that need not be transmitted between applications or among components of a computer program. One embodiment of the present invention is directed towards a method for generating a decision procedure, as embodied in 416 and 516, for regulating communication of information in a data structure, such as an object, between applications or among components of a computer program. Another embodiment of the present invention is directed towards a method for indicating to a computer programmer those portions of a data structure that need not be transmitted between applications or among components of a computer program.

FIG. 6 is a flow chart depicting the control flow of the process of identifying portions of a data structure, in one embodiment of the present invention. FIG. 6 shows the sequence of events that occur during the process of determining which portions of a data structure must be marshaled for transmission to a second node 104. The control flow of FIG. 6 begins with step 602 and flows directly to step 604.

In step 604, a computer program is read. This entails the reading of the source code of a computer program. Alternatively, the object code or executable code of a computer program can be read. In step 606, a send-receive graph is generated for the computer program that was read. A send-receive graph is a summary of the communication pattern of the computer program. The send-receive graph can be either specified by a human or generated automatically.

In a simple application, the sending computer program component might contain only one call to a send(x) function or method and the receiving computer program component only one call to a recv( ) function. The information-flow relationship between points in different computer program components can be characterized by a send-receive graph. In this simple case, the send-receive graph consists of a pair of points S, R, wherein S represents the statement send(x) in the sender, and R represents the statement recv( ) in the receiver, resulting in a single directed edge (S,R) connecting the sender and receiver. The send-receive graph for a more complex application may have more sender and/or receiver nodes and more edges between them.

In step 608, given a send-receive graph G for a send node/receive node pair, such as nodes 102 and node 104, the present invention generates an abstraction that summarizes the shape of a data structure at each send operation in the send node 102 computer program. In this context, shape is defined to be any abstract representation of a data structure that represents properties of the data structure. The abstraction may record information such as types of objects in the data structure, allocation sites between objects in the data structure, or relationships between objects in the data structure. The invention will generate such an abstraction using any of a number of program analysis techniques variously known in the literature as pointer analysis, abstract interpretation, or shape analysis.

In step 610, for each such send operation, the corresponding receive operation(s) in the receive node 104 is/are identified. At each such receive operation, it is assumed that the shape of the data structure received matches the shape described by the summary at the corresponding send operation in the send node 102.

In step 612, the shape information summarized in the receive node 104 during step 610 is incorporated into the program analysis method employed to generate shape abstractions in the receiver program. That is, the method of program analysis (pointer analysis, abstract interpretation, or shape analysis) is modified to assume that the data structure received at 104 conforms to the indicated shape. Then, in step 612, the process re-computes the program analysis incorporating this assumption. Using this new assumption, the program analysis may or may not compute a new value of the shape abstraction for some data structure at some program point in the receiver program. In step 614, it is determined whether this is the case. If the result of determination of step 614 is affirmative, then control flows to step 608, which is repeated. Otherwise, no such shape abstraction has changed and control flows to step 616.

In step 616, for each data structure modeled at a receive operation, it is computed which portion(s) of that data structure are required for correct computer program execution. In step 618, any portions of any data structures which step 616 fails to identify as required, are not required, and thus need not be included in the corresponding message, i.e., need not be marshaled for sending. In step 620, the control flow of FIG. 6 stops.

Below is an example showing the process of FIG. 6. Consider two programs A and B, which communicate objects of type Cell:

class Cell {

String x = null;
String y = null;}

Program A:

MainA( ) {
1: Cell c = new Cell( );
2: c.x = “Hello”;
3: send(B, c);
4: Cell r = recv(B);
5: print (r.x); }

Program B:

MainB( ) {
6: Cell q = recv(A);
7: q.y = “Goodbye”;
8: send(A,q);}

Starting with step 604, the source code above is read. In step 606, a send-receive graph is generated for this example. The notation X@y=>W@z means that program X at line y sends a message to program W which is received at line z. In our example, the following nodes and edges are defined:

A@3=>B@6

B@8=>A@4

In step 608, an abstraction is computer for each data structure at every send point in each program. In this example, step 608 computes shape abstractions using a standard flow-sensitive alias analysis technique, which will be well-understood by those skilled in the art of program analysis. It is assumed that data structures received are empty. The following result is computed for A:

—at line 3, c.x=“Hello” and c.y=null

And the following result is computed for B:

—at line 8:q.x=null and q.y=“Goodbye”

In step 610, the above information is incorporated at receive points, resulting in the following:

Since A@3−>B@6, at line 6, q.x=“Hello” and q.y=null

Since B@8−>A@4, at line 4, r.x=null and q.y=“Goodbye”

In step 612, the above information is incorporated and in step 614, control flows back to step 608, which is repeated. Using the updated information, step 608 produces:

—at line 3, c.x=“Hello” and c.y=null

—at line 8: q.x=“Hello” and q.y=“Goodbye”

Repeating step 610 with the new solution, the following is computed:

Since A@3−>B@6, at line 6, q.x=“Hello” and q.y=null

Since B@8−>A@4, at line 4, r.x=“Hello” and q.y “Goodbye”

In step 612, the above information is incorporated and in step 614, the new solution, shows that:

—at line 3, c.x=“Hello” and c.y=null

—at line 8: q.x=“Hello” and q.y=“Goodbye”

At this point, the solution has reached a fixed point and the system has reached the same solution in two consecutive executions. Thus, the analysis proceeds to step 616. Attention is brought to the recv( ) operation at line 4. Using dataflow analysis, step 616 computes that downstream from line 4, program A will use field r.x (at line 5) but not field r.y. Step 618 concludes that messages that are received at line 4 need not contain they field of the Cell data structure. Since B@8=>A@4, the system optimizes execution by excluding the q.y data when marshalling the message sent at line 8.

As explained above, the present invention is directed towards a method for identifying portions of a data structure that need not be transmitted between applications or among components of a computer program. One embodiment of the conclusion of step 618 above (as to which portions need not be marshaled) can be embodied in a decision procedure, as embodied in 416 and 516, that is executed before data is marshaled between applications or among components of a computer program. Another embodiment of the conclusion of step 618 above is an interface that indicates to a computer programmer those portions of a data structure that need not be marshaled. The computer programmer can utilize this information to decide whether to modify the source code according to the recommendations of a decision procedure.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following: a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

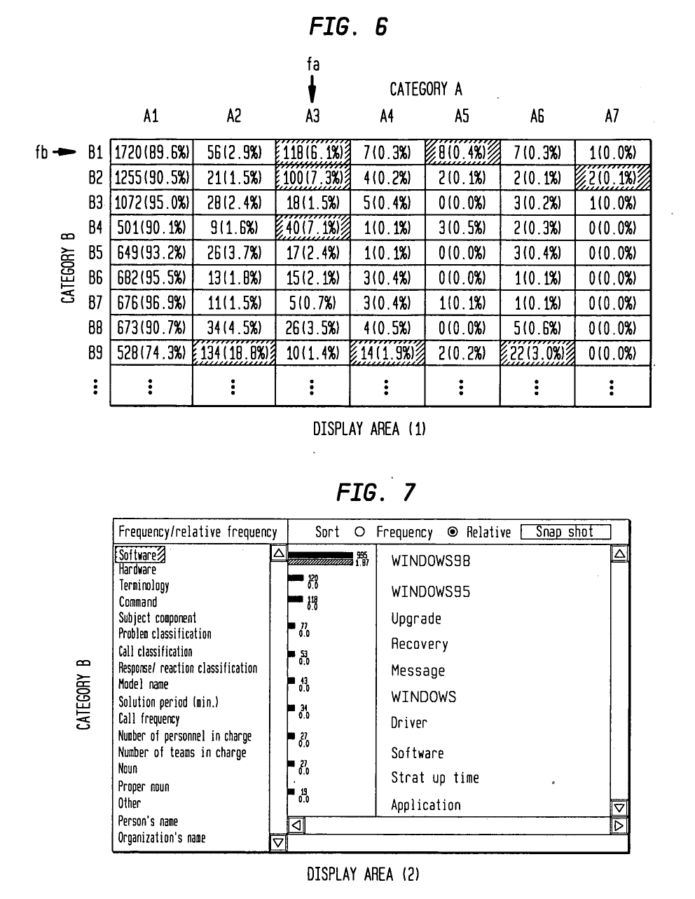

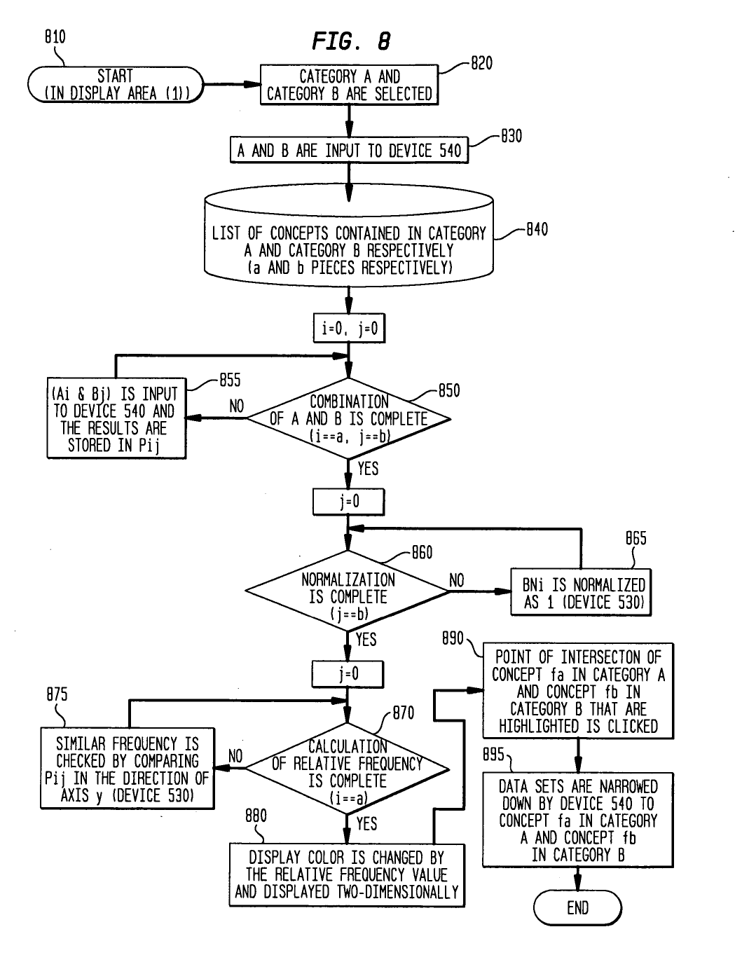

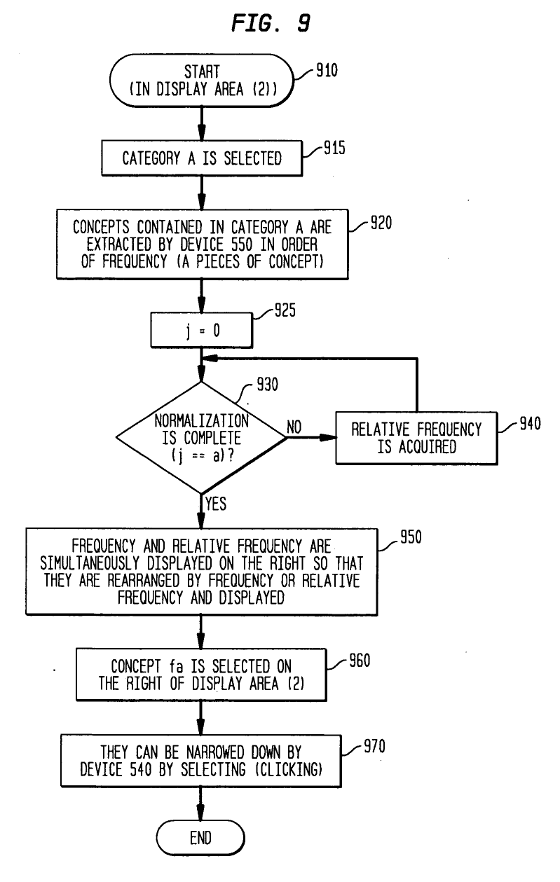

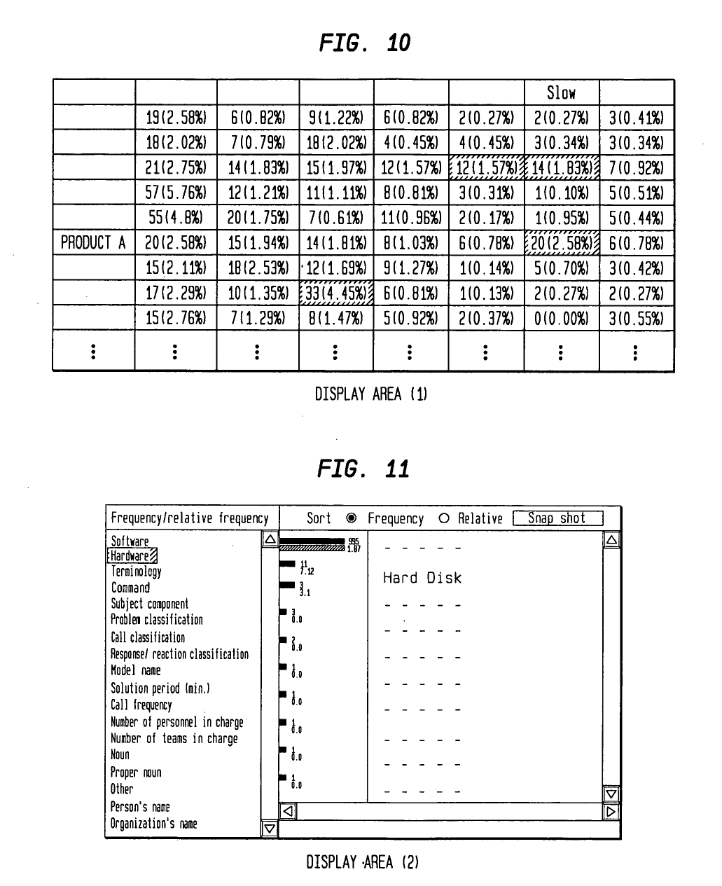

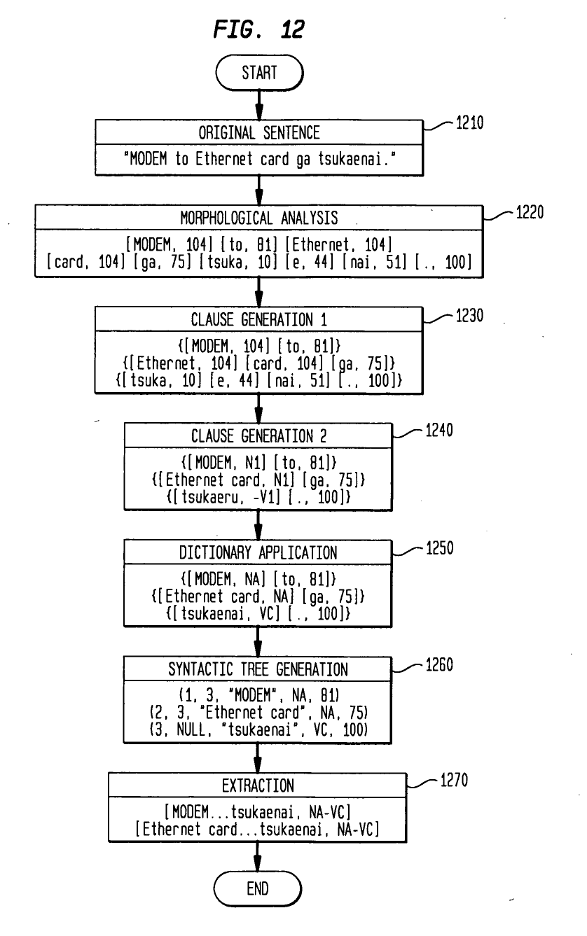

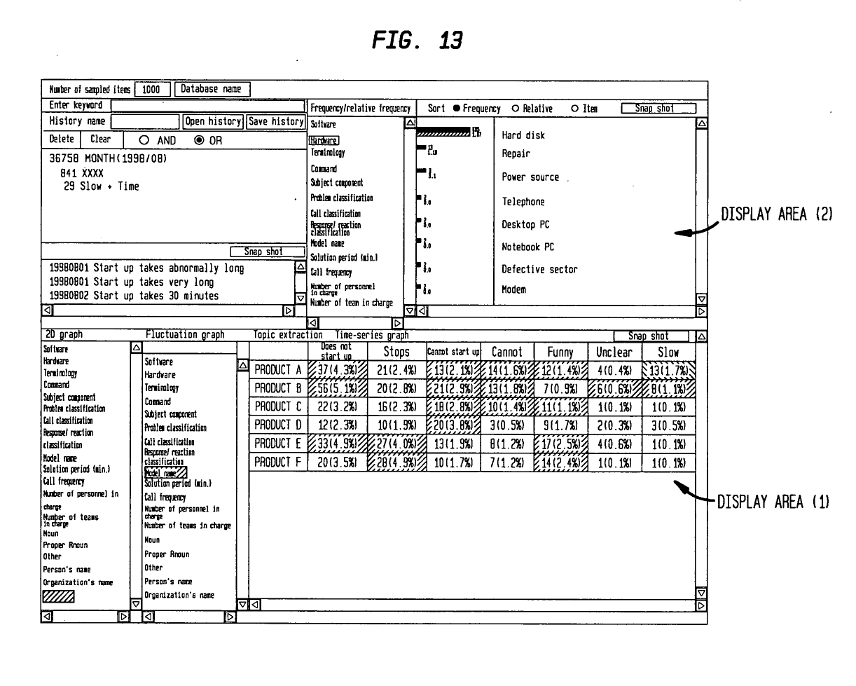

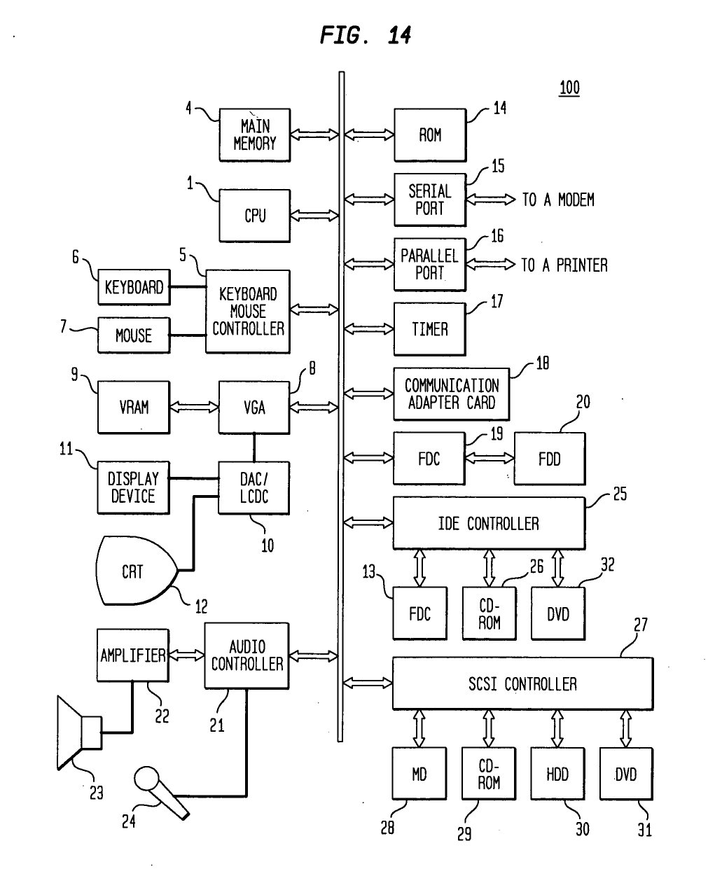

FIG. 7 is a high level block diagram showing an information processing system useful for implementing one embodiment of the present invention. The computer system includes one or more processors, such as processor 704. The processor 704 is connected to a communication infrastructure 702 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 708 that forwards graphics, text, and other data from the communication infrastructure 702 (or from a frame buffer not shown) for display on the display unit 710. The computer system also includes a main memory 706, preferably random access memory (RAM), and may also include a secondary memory 712. The secondary memory 712 may include, for example, a hard disk drive 714 and/or a removable storage drive 716, representing a floppy disk drive, a magnetic tape drive, an optical disk drive, etc. The removable storage drive 716 reads from and/or writes to a removable storage unit 718 in a manner well known to those having ordinary skill in the art. Removable storage unit 718, represents a floppy disk, a compact disc, magnetic tape, optical disk, etc. which is read by and written to by removable storage drive 716. As will be appreciated, the removable storage unit 718 includes a computer readable medium having stored therein computer software and/or data.

In alternative embodiments, the secondary memory 712 may include other similar means for allowing computer programs or other instructions to be loaded into the computer system. Such means may include, for example, a removable storage unit 722 and an interface 720. Examples of such may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to the computer system.

The computer system may also include a communications interface 724. Communications interface 724 allows software and data to be transferred between the computer system and external devices. Examples of communications interface 724 may include a modem, a network interface (such as an Ethernet card), a communications port, a PCMCIA slot and card, etc. Software and data transferred via communications interface 724 are in the form of signals which may be, for example, electronic, electromagnetic, optical, or other signals capable of being received by communications interface 724. These signals are provided to communications interface 724 via a communications path (i.e., channel) 726. This channel 726 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 706 and secondary memory 712, removable storage drive 716, a hard disk installed in hard disk drive 714, and signals. These computer program products are means for providing software to the computer system. The computer readable medium allows the computer system to read data, instructions, messages or message packets, and other computer readable information from the computer readable medium.

Computer programs (also called computer control logic) are stored in main memory 706 and/or secondary memory 712. Computer programs may also be received via communications interface 724. Such computer programs, when executed, enable the computer system to perform the features of the present invention as discussed herein. In particular, the computer programs, when executed, enable the processor 704 to perform the features of the computer system. Accordingly, such computer programs represent controllers of the computer system.

What has been shown and discussed is a highly-simplified depiction of a programmable computer apparatus. Those skilled in the art will appreciate that other low-level components and connections are required in any practical application of a computer apparatus.

Therefore, while there has been described what is presently considered to be the preferred embodiment, it will be understood by those skilled in the art that other modifications can be made within the spirit of the invention.

What is claimed is:

1. A method for regulating communication of information in a data structure between components of a computer program, the method comprising:
reading a computer program;
automatically identifying fields of a data structure that must be transmitted from a first component of the computer program to a second component of the computer program;
generating a routine that indicates the fields of the data structure that were identified; and
requiring the first component to execute the routine when sending the data structure to the second component, such that the first component only marshals the fields of the data structure that are indicated by the routine.

2. The method of claim 1, wherein the element of reading comprises:
reading the source code of a computer program.

3. The method of claim 1, wherein the element of identifying comprises:
automatically identifying fields of an object that must be transmitted from a first component of the computer program to a second component of the computer program.

4. The method of claim 3, wherein the element of generating comprises:
generating a function or method that indicates the fields of the object that were identified.

5. The method of claim 4, wherein the element of requiring comprises:
requiring the first component to execute the function or method when sending the object to the second component, such that the first component only marshals the fields of the object that are indicated by the function or method.

6. The method of claim 1, wherein the element of identifying comprises:
creating a send-receive graph for the first component and the second component of the computer program;
computing abstractions representing data structures at each send operation for the first and the second component, using program analysis;
incorporating the abstractions at each send operation to the corresponding receive operation, using the send-receive graph;
re-computing the abstractions in the first and second components based on the previous step, using program analysis;
executing the computing, incorporating and re-computing steps if at least one of the abstractions have changed after the re-computing step;
determining which fields of a data structure must be transmitted, based on the computed abstractions, from the first component to the second component, using program analysis, if no abstractions have changed after the re-computing step.

7. The method of claim 1, wherein the element of generating comprises:
generating a function or method that indicates the fields of the data structure that were identified.

8. The method of claim 7, wherein the element of requiring comprises:
requiring the first component to execute the function or method when sending the data structure to the second component, such that the first component only marshals the fields of the data structure that are indicated by the function or method.

9. An information processing system for regulating communication of information in a data structure between components of a computer program, comprising:
a reader for reading a computer program;
a processor configured for:
automatically identifying fields of a data structure that must be transmitted from a first component of the computer program to a second component of the computer program;
generating a routine that indicates the fields of the data structure that were identified; and
requiring the first component to execute the routine when sending the data structure to the second component, such that the first component only marshals the fields of the data structure that are indicated by the routine.

10. The information processing system of claim 9, wherein the reader is for reading the source code of a computer program.

11. The information processing system of claim 9, wherein the data structure is an object.

12. The information processing system of claim 11, wherein the element of generating comprises:
generating a function or method that indicates the fields of the object that were identified.

13. The information processing system of claim 12, wherein the element of requiring comprises:
requiring the first component to execute the function or method when sending the object to the second component, such that the first component only marshals the fields of the object that are indicated by the function or method.

14. The information processing system of claim 9, wherein the element of generating comprises:
generating a function or method that indicates the fields of the data structure that were identified.

15. The information processing system of claim 14, wherein the element of requiring comprises:
requiring the first component to execute the function or method when sending the data structure to the second component, such that the first component only marshals the fields of the data structure that are indicated by the function or method.

16. A computer readable medium including computer instructions for regulating communication of information in a data structure between components of a computer program, the computer instructions including instructions for:
reading a computer program;
automatically identifying fields of a data structure that must be transmitted from a first component of the computer program to a second component of the computer program;
generating a routine that indicates the fields of the data structure that were identified; and
requiring the first component to execute the routine when sending the data structure to the second component, such that the first component only marshals the fields of the data structure that are indicated by the routine.

17. The computer readable medium of claim 16, wherein the instructions for reading comprise instructions for:
reading the source code of a computer program.

18. The computer readable medium of claim 16, wherein the instructions for identifying comprise instructions for:
automatically identifying fields of an object that must be transmitted from a first component of the computer program to a second component of the computer program.

19. The computer readable medium of claim 18, wherein the instructions for generating comprise instructions for:
generating a function or method that indicates the fields of the object that were identified.

20. The computer readable medium of claim 16, wherein the instructions for identifying comprise instructions for:
creating a send-receive graph for the first component and the second component of the computer program;
computing abstractions representing data structures at each send operation for the first and the second component, using program analysis;
incorporating the abstractions at each send operation to the corresponding receive operation, using the send-receive graph;
re-computing the abstractions in the first and second components based on the previous step, using program analysis;
executing the computing, incorporating and re-computing steps if at least one of the abstractions have changed after the re-computing step; and
determining which fields of a data structure must be transmitted, based on the computed abstractions, from the first component to the second component, using program analysis, if no abstractions have changed after the re-computing step.
